(19) United States
(12) Patent Application Publication
(10) Pub. No.: US 2025/0165854 A1
(43) Pub. Date: May 22, 2025

(54) QUANTIZATION COMPENSATION FOR MACHINE LEARNING MODELS

(71) Applicant: QUALCOMM Incorporated, San Diego, CA (US)

(72) Inventors: Simyung CHANG, Suwon (KR); Jaeseong YOU, Seoul (KR); Minseop PARK, Young-in (KR); Kyuhong SHIM, Seoul (KR); Kyu Woong HWANG, Daejeon (KR)

(21) Appl. No.: 18/514,602

(22) Filed: Nov. 20, 2023

(51) Int. Cl. G06N 20/00

(52) U.S. Cl. CPC G06N 20/00

(57) ABSTRACT

Certain aspects of the present disclosure provide techniques and apparatus for improved machine learning. A first machine learning model comprising a first plurality of blocks is accessed, the first plurality of blocks being associated with a first precision. A second machine learning model comprising a second plurality of blocks associated with a second precision, where the second plurality of blocks comprises a first block that corresponds to a first block of the first plurality of blocks. An input to the first machine learning model is processed using the first plurality of blocks and the second plurality of blocks, comprising modifying an output of the first block of the first plurality of blocks based on the corresponding first block of the second plurality of blocks. An output of the first machine learning model is provided based on the processing.

### INTRODUCTION

Aspects of the present disclosure relate to machine learning.

A wide variety of machine learning architectures have recently been used to perform innumerable tasks with high accuracy and reliability. For example, computer vision models have been used to perform tasks such as object detection and distance prediction. As another example, language models (e.g., large language models (LLMs)) have been used to understand and generate textual output in a human-like fashion, such as for use in chat bots. However, many existing model architectures are large (e.g., having thousands, millions, or billions of parameters), and training such models generally relies on vast amounts of training data (and incurs similarly vast computational expense).

Some conventional approaches to improve accessibility to machine learning (e.g., on edge devices with limited compute) include model quantization. Though quantization can reduce the model size substantially, quantization also introduces inherent error due to the fact that high-precision model parameters are approximated using lower-precision values.

### BRIEF SUMMARY

Certain aspects of the present disclosure provide a processor-implemented method, comprising: accessing a first machine learning model comprising a first plurality of blocks, the first plurality of blocks being associated with a first precision and comprising a first block; accessing a second machine learning model comprising a second plurality of blocks associated with a second precision different from the first precision, wherein: the second plurality of blocks comprises a first block; and the first block of the second plurality of blocks corresponds to the first block of the first plurality of blocks; processing an input to the first machine learning model using the first plurality of blocks of the first machine learning model and the second plurality of blocks of the second machine learning model, wherein the processing comprises modifying an output of the first block of the first plurality of blocks based on the corresponding first block of the second plurality of blocks; and providing an output of the first machine learning model based on the processing.

Certain aspects of the present disclosure provide a processor-implemented method, comprising: accessing a first machine learning model comprising a first plurality of blocks; generating a second machine learning model comprising a second plurality of blocks by quantizing the baseline machine learning model; training a third machine learning model comprising a third plurality of blocks for adjusting for the quantization of the first machine learning model; and deploying the second machine learning model and the third machine learning model for inferencing.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the present disclosure and are therefore not to be considered limiting of the scope of this disclosure.

FIG. 1 depicts an example workflow for compensating and adapting quantized machine learning models, according to some aspects of the present disclosure.

FIGS. 2A, 2B, and 2C depict example workflows for generating output using quantization-compensated machine learning models, according to some aspects of the present disclosure.

FIG. 3 is a flow diagram depicting an example method for compensating and adapting quantized machine learning models, according to some aspects of the present disclosure.

FIG. 4 is a flow diagram depicting an example method for training quantization compensation models, according to some aspects of the present disclosure.

FIG. 5 is a flow diagram depicting an example method for adapting quantization compensation models, according to some aspects of the present disclosure.

FIG. 6 is a flow diagram depicting an example method for generating output using quantization-compensated machine learning models, according to some aspects of the present disclosure.

FIG. 7 is a flow diagram depicting an example method for using machine learning models to compensate for quantization, according to some aspects of the present disclosure.

FIG. 8 is a flow diagram depicting an example method for training machine learning models to compensate for quantization, according to some aspects of the present disclosure.

FIG. 9 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing improved machine learning.

In some aspects, a baseline machine learning model (e.g., an LLM) may be quantized using one or more quantization operations to yield a quantized version of the model, where the quantized version is relatively smaller (e.g., each parameter can be stored in relatively fewer bits, as compared to the non-quantized baseline model) in terms of memory footprint. Generally, to quantize a model, one or more of the model parameters (which are often represented in high-precision formats, such as 16-bit floating point) are approximated using fewer bits (e.g., an eight- or four-bit representation). As the resulting quantized weights are stored using fewer bits, the size of the model can be substantially reduced. However, such quantization inherently introduces quantization error, where the output of a quantized model is generally less accurate or reliable than the output of the non-quantized model. Generally, more aggressive quantization schemes (e.g., quantizing to four-bits rather than eight) results in reduced size, but increased error.

In some aspects of the present disclosure, the quantized baseline model may have its weights frozen, and one or more small and high-precision compensation components may be trained to compensate for (or at least reduce) the quantization error. For example, the compensation modules may be less than one percent of the size of the quantized model. Generally, small compensation blocks are substantially easier to train (e.g., involving fewer computational resources and fewer exemplars), as compared to the much larger baseline model. However, such compensation modules can significantly improve model accuracy. For example, a model quantized to four-bit resolution may be augmented with a set of small sixteen-bit compensation modules, and the resulting combination may produce output with accuracy that is comparable to much larger quantized resolutions (e.g., an eight-bit quantized model without compensation modules, which is roughly twice as large as the four-bit quantized model).

Generally, the size of a machine learning model is a product of the number of parameters and the resolution (e.g., bit width) used to store the parameters. Using aspects of the present disclosure, a model with relatively many parameters encoded in relatively low resolution can be coupled with compensation model(s) having relatively few parameters encoded at a relatively higher resolution. This combined model can provide comparable (or improved) accuracy over a model with many parameters encoded at high resolution, while using substantially less memory space and computational resources.

In some aspects, in addition to training the compensation module(s) to compensate for (or at least reduce) quantization error, task-specific data may also be used to train the compensation module(s) (while keeping the quantized baseline model frozen). This efficient task adaptation can similarly be performed with minimal resources (e.g., on edge devices), and may result in substantial improvements in model output. For example, combining a four-bit quantized machine learning model with a sixteen-bit compensation model that has been trained using task data may generate more accurate output than the original (non-quantized) model itself, which may be substantially larger (e.g., a sixteen-bit floating point format, which is approximately four times larger).

In some aspects, the quantized machine learning model and the compensation model may be executed or processed using different hardware components, depending on the particular implementation. For example, the quantized model may be deployed (e.g., processed) using a first component (e.g., a first integrated circuit (IC) device) that is relatively more optimal for the low-precision (e.g., four-bit) representation and/or for the larger number of parameters (e.g., to a component that can process many parameters in parallel), while the compensation model may be deployed to a second hardware component (e.g., a second IC device) that is relatively more optimal for the higher-precision (e.g., sixteen-bit) and/or for the smaller number of parameters. In this way, the combined model (including the quantized model and the compensation model) may be executed efficiently. In some aspects, portions of the model may be executed in parallel. For example, depending on the particular implementation, each block of the quantized model may be executed by one hardware component substantially in parallel with the first component with a corresponding block of the compensation model being processed using a second hardware component.

In some aspects, the compensation model may be trained block-wise (e.g., on a per-layer basis) and/or end-to-end. As used herein, a “block” of a machine learning model generally corresponds to a logical segment of the model, such as a layer (of a neural network), a transformer, an MLP, and the like. In some aspects, for each block of the quantized model, a corresponding compensation block of the compensation model may be trained. In some aspects, training the compensation model block-wise may generally include seeking to minimize the loss with respect to intermediate features generated by corresponding blocks, while training end-to-end may generally include seeking to minimize the loss with respect to the overall model output.

In some aspects, the compensation model is trained as defined using Equation 1 below, where θ is the parameters of the compensation model C, F(x) is the output of the original (non-quantized) machine learning model given input x (or the output of a [symbol] given block of the original model), [symbol] is the output of the quantized machine learning model given input x (or the output of the quantized block of the quantized model that corresponds to the given block), and C_{θ}(x) is the output of the compensation model (or the compensation block that corresponds to the given block of the original model).

$$arg {min}_{θ} {‖ F ( x ) - ( + {C}_{θ} ( x ) ) ‖}_{p} \qquad ( 1 )$$

Advantageously, because the compensation model generally has substantially fewer parameters (as compared to the baseline model), the compensation model can be effectively trained on a much wider variety of devices (e.g., resource-constrained devices such as, but not limited to, personal smartphones, tablets, wearable devices, Internet of Things (IoT) devices, and the like), as compared to the baseline model. Further, substantially fewer training exemplars may be used to train the smaller compensation model. This allows for efficient compensation and adaptation by end users. Further, such on-device training can enhance or preserve user privacy (e.g., because personal data need not be provided to a more powerful training server, which may be remote and/or cloud-based). Additionally, in some aspects, as the baseline model and quantized model are frozen during training of the compensation model, the optimization states for the larger model, which are conventionally saved and used throughout training, need not be stored. This further reduces the resources used to train the compensation model. Additionally, as the compensation model can be implemented using conventional high-precision (e.g., sixteen-bit floating point) parameters, the compensation model can be trained using a standard approach, eliminating the use of extra operations often used to enable learning quantized weights.

### Example Workflow for Compensating and Adapting Quantized Machine Learning Models

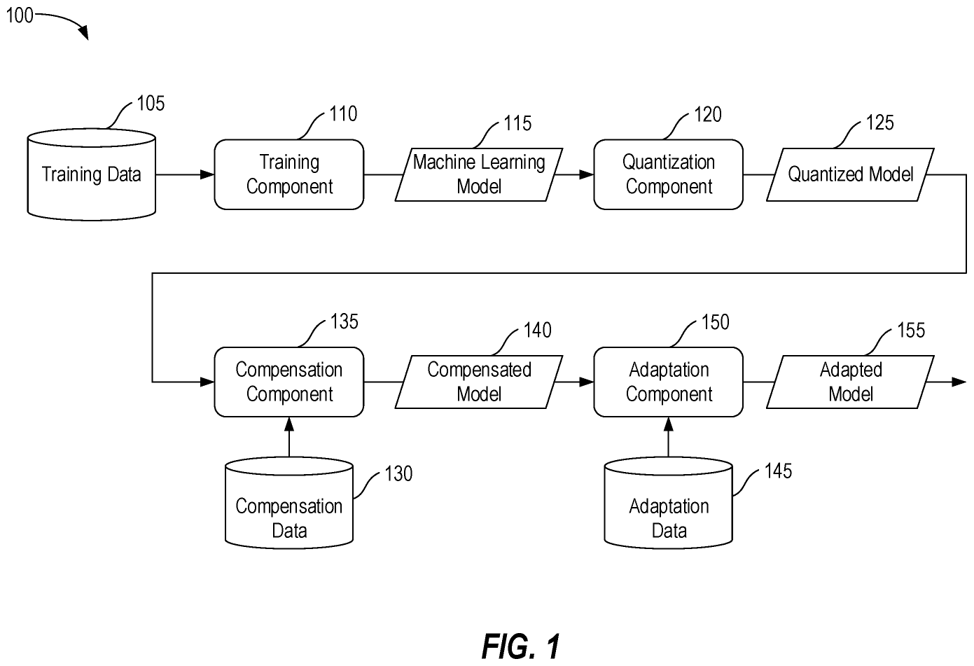

FIG. 1 depicts an example workflow 100 for compensating and adapting quantized machine learning models, according to some aspects of the present disclosure. In some aspects, the workflow 100 is implemented by one or more processing systems, such as by a machine learning system that trains machine learning models, a machine learning system that uses trained models for inferencing (e.g., an edge device), and the like.

In some aspects, the operations depicted in the workflow 100 and discussed in more detail below may be distributed across multiple devices and systems. That is, the training component 110, quantization component 120, compensation component 135, and adaptation component 150 (which may each be implemented using hardware, software, or a combination of hardware and software) may be components of a single processing system or may be distributed across multiple processing systems. For example, in some aspects, the training component 110, quantization component 120, and/or compensation component 135 may be implemented by a server that performs model training, while the adaptation component 150 may be implemented by a device that will use the trained models during inference.

In the illustrated workflow 100, a set of training data 105 is accessed by a training component 110. As used herein, “accessing” data may generally include receiving, requesting, retrieving, generating, collecting, obtaining, or otherwise gaining access to the data. Although depicted as a discrete repository of training data 105 for conceptual clarity, in some aspects, the training data 105 may be distributed across any number of repositories or other data sources. The particular format and content of the training data 105 may vary depending on the particular task for which the machine learning model is being trained. For example, for a computer vision task, the training data 105 may include images and corresponding labels (e.g., segmentation maps, classifications, and the like). As another example, if an LLM is being trained, the training data 105 may include textual exemplars.

As illustrated, the training component 110 uses the training data 105 to generate (e.g., train) a machine learning model 115. The particular architecture of the machine learning model 115 may vary depending on the particular implementation, and may include architectures such as LLMs, CNNs, transformer-based models, and the like. In some aspects, as discussed above, the machine learning model 115 may be referred to as a baseline model. The parameters of the machine learning model 115 are generally represented or encoded using a high-precision value representation, such as sixteen-bit floating point.

In the illustrated workflow 100, the machine learning model 115 is accessed by a quantization component 120. The quantization component 120 is generally configured to quantize the parameters of the machine learning model 115 to a lower bit-width representation, thereby reducing the size of the model. As illustrated, this results in a quantized model 125. For example, the parameters of the quantized model 125 may be represented or encoded using a lower-precision value representation, such as four-bit or eight-bit integer. In some aspects, the quantized model 125 may be referred to as a “quantized machine learning model” and/or a “quantized version” of the baseline machine learning model. In some aspects, quantization may cause at least some of the parameters of the quantized model 125 to have a value of zero. In some aspects, therefore the quantization component 120 may prune such zero-value parameters from the quantized model 125, further reducing its size and number of parameters.

As illustrated, the quantized model 125 is then accessed by a compensation component 135. The compensation component 135 uses a set of compensation data 130 to generate (e.g., train) a compensated model 140. In some aspects, the compensation data 130 may alternatively be referred to as adjustment data. In some aspects, the compensated model 140 is an ensemble comprising the quantized model 125 and a separate compensation model. In some aspects, as discussed above, the parameters of the compensation model may be represented or encoded using a higher-precision value representation, such as sixteen-bit floating point. However, as the compensation model may have far fewer parameters than the quantized model 125 (e.g., less than 1%), the overall size of the compensated model 140 may be negligibly larger than the quantized model 125.

In some aspects, the compensation data 130 generally includes data from the same task as the training data 105. For example, if the training data 105 comprises image inputs, the compensation data 130 may similarly comprise images. In some aspects, the compensation data 130 need not include labels. That is, though exemplars in the training data 105 may have corresponding ground-truth labels to facilitate training of the machine learning model 115, the compensation data 130 may not have such labels. For example, as the compensation model is trained to minimize (or at least reduce) the difference between the quantized model 125 and the machine learning model 115, the actual ground-truth of the output is irrelevant during training.

In some aspects, to train the compensation model, the compensation component 135 can generate a first output by processing an exemplar from the compensation data 130 using the machine learning model 115, a second output by processing the exemplar using the quantized model 125, and a third output by processing the exemplar using the compensation model. The compensation component 135 may then compute a loss between the first output and an aggregation (e.g., sum) of the second and third outputs. This loss may be used to refine the parameters of the compensation model (e.g., using backpropagation). As discussed above, this training may be performed block-wise (e.g., computing a loss with respect to the intermediate features generated by each block) and/or end-to-end (e.g., computing a loss with respect to the final model outputs). Similarly, this training may be performed using individual exemplars (e.g., stochastic gradient descent) and/or in batches of exemplars (e.g., using batch gradient descent).

In some aspects, the compensated model 140 may thereafter be deployed or provided to an inferencing system for use. For example, the compensated model 140 may be generated by a first system (e.g., a server that performs model training and quantization) and deployed to a second system (e.g., a user device such as a laptop or smartphone). In some aspects, rather than being used for inferencing, the compensated model 140 may be accessed by an adaptation component 150 (e.g., on the training server or on the edge device).

As illustrated, the adaptation component 150 accesses adaptation data 145 and generates (e.g., trains) an adapted model 155. In some aspects, the adaptation data 145 generally includes data from the same task as the training data 105 (e.g., images), but for a target domain (where the training data 105 may be from a source domain). For example, the adaptation data 145 may include image exemplars that are specific to the user or system that will use the adapted model 155 (whereas the training data 105 may be agnostic or generic across a large number of users). Such task-specific data can enable effective task-adaptation, resulting in substantially improved predictions using a personalized model.

In some aspects, the adaptation data 145 includes ground-truth labels in a similar manner to the training data 105. In some aspects, to train the adapted model 155, some parameters of the compensated model 140 (e.g., the parameters of the quantized model 125) may be frozen or static (e.g., unchanged), while other parameters (e.g., the parameters of the compensation model) may be updated.

In some aspects, to train the adapted model 155, the adaptation component 150 can generate an output by processing an exemplar from the adaptation data 145 using the compensated model 140. The adaptation component 150 may then compute a loss between the output and the ground-truth label for the exemplar. This loss may be used to refine the parameters of the compensation portion of the compensated model 140 (e.g., using backpropagation). As discussed above, this training may be performed block-wise (e.g., computing a loss with respect to the intermediate features generated by each block) and/or end-to-end (e.g., computing a loss with respect to the final model outputs). Similarly, this training may be performed using individual exemplars (e.g., stochastic gradient descent) and/or in batches of exemplars (e.g., using batch gradient descent). In some aspects, the quantized portion of the compensated model 140 is frozen during adaptation.

As illustrated, the adapted model 155 may then be deployed or otherwise provided for inferencing. For example, the adapted model 155 may be deployed or implemented on one or more hardware components and used to process input data to generate outputs during runtime.

Advantageously, the adapted model 155 is generally substantially smaller (in terms of size or memory footprint) as compared to the machine learning model 115, but may exhibit comparable (or improved) accuracy.

### Example Workflows for Generating Output Using Quantization-Compensated Machine Learning Models

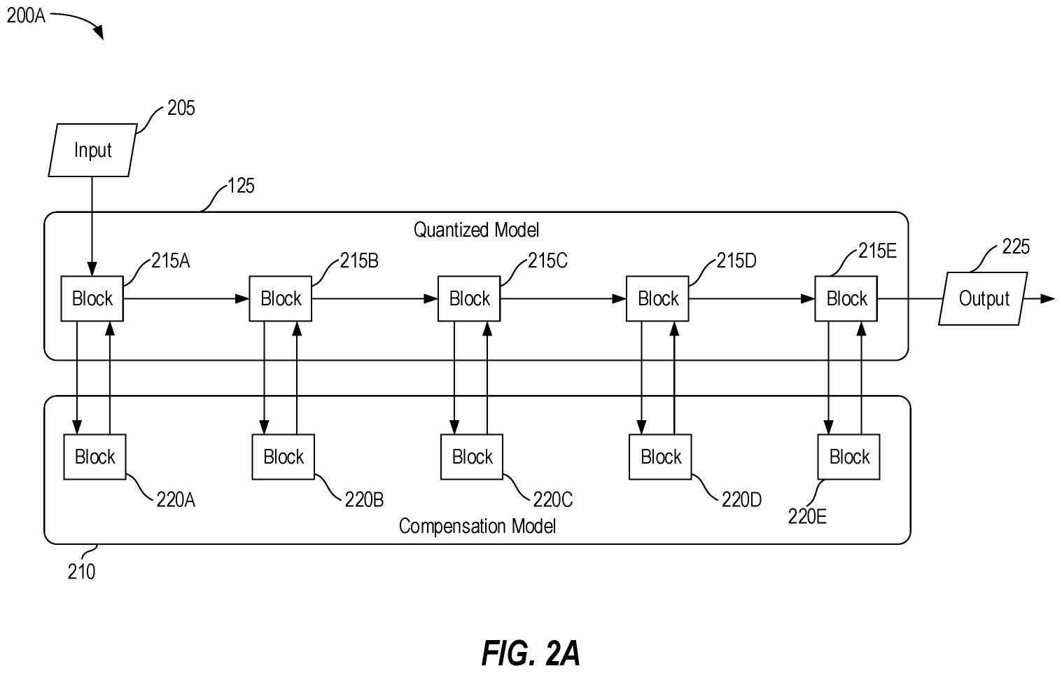

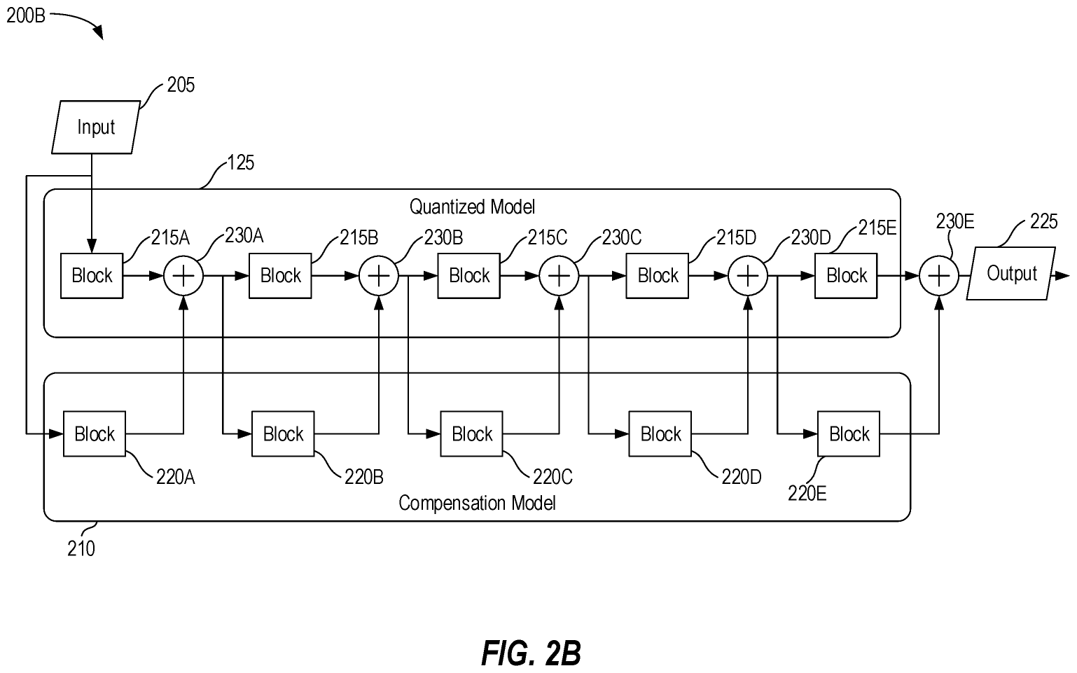

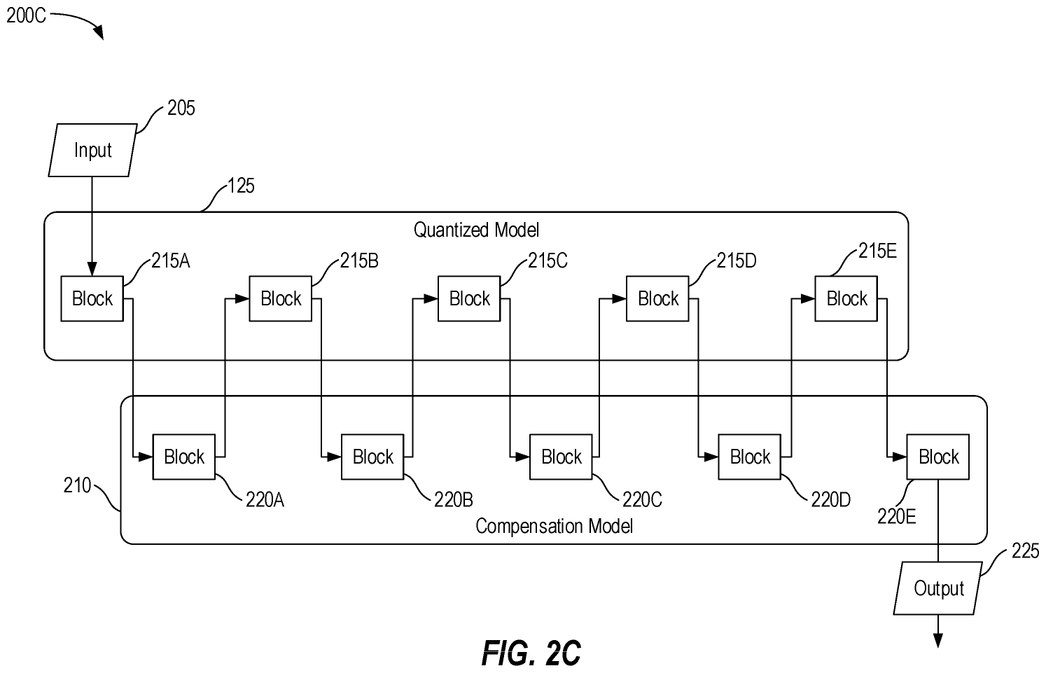

FIGS. 2A, 2B, and 2C depict example workflows 200A-C for generating output using quantization-compensated machine learning models, according to some aspects of the present disclosure. In some aspects, the workflows 200A-C are implemented by one or more processing systems, such as the machine learning systems discussed above with reference to FIG. 1.

Specifically, the workflow 200A of FIG. 2A depicts an architecture where blocks of the compensation model process intermediate features as part of the computation of each block of the quantized model, the workflow 200B of FIG. 2B depicts an architecture where each block of the compensation model works in parallel with a corresponding block in the quantized model to generate input to the subsequent block, and the workflow 200C of FIG. 2C depicts an architecture where the output of each block of the quantized model is transformed or updated by a corresponding block of the compensation model. Generally, the workflows 200A-C (collectively, the workflows 200) may represent alternative or various implementations of the ensemble compensated model, and each may be used in a given model. That is, elements of each architecture may be combined to form a single compensated model, in some aspects.

As depicted in FIG. 2A, an ensemble compensated model (which may correspond to the compensated model 140 of FIG. 1) comprises a quantized model 125 and a compensation model 210. The quantized model 125 comprises a set of blocks 215A-E (collectively, blocks 215), while the compensation model 210 comprises a corresponding set of blocks 220A-E (collectively, blocks 220). In some aspects, the quantized model 125 comprises an ordered set or sequence of blocks 215, which are processed sequentially.

Generally, the particular operations performed by each block 215 and 220 may vary depending on the particular implementation. For example each block 215 and 220 may perform one or more convolution operations, attention operations, transformer operations, and the like. In some aspects, each of the blocks 220 of the compensation model 210 comprises a multilayer perceptron (MLP).

In the illustrated workflow 200A, an input 205 is accessed by a first block 215A of the quantized model 125. As illustrated, the block 215A performs one or more operations or transformations (e.g., convolutions) on the input 205 to generate a first set of intermediate features. These features are then provided to the first block 220A (which corresponds to the block 215A), which performs one or more operations (e.g., convolutions) to generate a second set of intermediate features. The second set of intermediate features are then processed by the block 215A to generate an output set of intermediate features from the block 215A. The output set of intermediate features are then used as input to the block 215B.

As illustrated, each block 215 of the quantized model 125 has a corresponding block 220 in the compensation model 210, where intermediate features of each block 215 are processed or transformed by the corresponding block 220, and the output of each block 215 is generated based at least in part on the (compensated) output of the corresponding block 220. As illustrated, the block 215E generates output 225 from the compensated model. As discussed above, the particular format and content of the input 205 and output 225 may vary depending on the particular implementation. For example, if the compensated model is an LLM architecture, then the input 205 and output 225 may both comprise natural language text.

Although five blocks 215 and 220 are depicted for conceptual clarity, there may be any number of blocks 215 and 220 in the quantized model 125 and compensation model 210. Further, although the illustrated example depicts a corresponding block 220 for each block 215, in some aspects, the compensation model 210 may include blocks 220 only for a subset of the blocks 215. For example, there may be a compensation block 220 for one or more earlier blocks 215 (e.g., for the first block 215A) and for one or more later blocks 215 (e.g., for the last block 215E), but one or more internal blocks 215 (e.g., the blocks 215B, 215C, and 215D) may lack corresponding compensation blocks 220.

In some aspects, for an architecture using the workflow 200A, the training system may train the compensation model 210 end-to-end and/or block-wise. In some aspects, to train the compensation model 210 end-to-end, the training system may update parameters of the blocks 220 (leaving the parameters of the blocks 215 unchanged) to seek to minimize (or at least reduce) the difference between the output 225 and a corresponding output that is generated when the input 205 is processed by the non-quantized baseline model. Similarly, to train the compensation model 210 block-wise, the training system may update the parameters of the blocks 220 to seek to minimize (or at least reduce) the difference between the output of each block 215 and the output of a corresponding block in the non-quantized baseline model.

Turning to FIG. 2B, the ensemble compensated model (which may correspond to the compensated model 140 of FIG. 1) similarly comprises a quantized model 125 and a compensation model 210, where the quantized model 125 comprises a set of blocks 215A-E (collectively, blocks 215), while the compensation model 210 comprises a corresponding set of blocks 220A-E (collectively, blocks 220). As discussed above, the particular operations performed by each block 215 and 220 may vary depending on the particular implementation.

In the illustrated workflow 200B, an input 205 is accessed by a first block 215A of the quantized model 125. As illustrated, the block 215A performs one or more operations or transformations (e.g., convolutions) on the input 205 to generate an output set of intermediate features. Additionally, as illustrated, the input 205 is also accessed by the first block 220A of the compensation model 210. The compensation model 210 similarly performs one or more operations (e.g., convolutions) to generate a second set of output features. In some aspects, as discussed above, the block 215A and the block 220A may be executed or processed in parallel (e.g., on different hardware components).

As illustrated, the output of the block 215A and the output of the block 220A is then combined via a corresponding aggregation operation 230A. The aggregation operation 230A may generally perform any number of operations, such as element-wise summation, element-wise averaging, element-wise max or min operations, and the like. Although depicted as a component of the quantized model 125, in some aspects, the aggregation operation 230A may be performed as a separate operation of the compensated model (e.g., not directly part of either the quantized model 125 or the compensation model 210).

In the illustrated example, the output of the aggregation operation 230A is then accessed by both the block 215B of the quantized model 125 and by the block 220B of the compensation model 210. The resulting outputs are again aggregated via a corresponding aggregation operation 230B, and this sequence is repeated for each block. As illustrated, the output 225 is generated by aggregating the final output of the block 215E and the block 220E using a corresponding aggregation operation 230E.

In the illustrated example, each block 215 of the quantized model 125 has a corresponding block 220 in the compensation model 210, where intermediate features of each block 215 are aggregated (via a corresponding aggregation operation 230) with the features generated by the corresponding block 220, and the aggregated output is then provided as input to the next block(s) (e.g., the next block 215 of the quantized model, and the next block 220 of the compensation model).

As discussed above, although five blocks 215 and 220 are depicted for conceptual clarity, there may be any number of blocks 215 and 220 in the quantized model 125 and compensation model 210. Further, although the illustrated example depicts a corresponding block 220 for each block 215, in some aspects, the compensation model 210 may include blocks 220 only for a subset of the blocks 215, as discussed above. For example, if there is no block 220B in the compensation model 210 (e.g., the block 215B of the quantized model 125 has no corresponding block in the compensation model 210), the output of the block 215B may instead be provided directly to the block 215C.

In some aspects, for an architecture using the workflow 200B, the training system may train the compensation model 210 end-to-end and/or block-wise. In some aspects, to train the compensation model 210 end-to-end, the training system may update parameters of the blocks 220 (leaving the parameters of the blocks 215 unchanged) to seek to minimize (or at least reduce) the difference between the output 225 and a corresponding output that is generated when the input 205 is processed by the non-quantized baseline model, as discussed above. Similarly, to train the compensation model 210 block-wise, the training system may update the parameters of the blocks 220 to seek to minimize (or at least reduce) the difference between the output of each aggregation operation 230 and the output of a corresponding block in the non-quantized baseline model.

Turning now to FIG. 2C, the ensemble compensated model (which may correspond to the compensated model 140 of FIG. 1) similarly comprises a quantized model 125 and a compensation model 210, where the quantized model 125 comprises a set of blocks 215A-E (collectively, blocks 215), while the compensation model 210 comprises a corresponding set of blocks 220A-E (collectively, blocks 220). As discussed above, the particular operations performed by each block 215 and 220 may vary depending on the particular implementation.

In the illustrated workflow 200C, an input 205 is accessed by a first block 215A of the quantized model 125, which generates an output set of features. These features are used as input to a corresponding block 220A of the compensation model 210. The block 220A then processes (e.g., transforms) the features using one or more operations. The transformed (e.g., compensated) features may then be provided as input to the subsequent block 215B of the quantized model 125. This process may be repeated for each block, until the output 225 is generated by the last block 220E of the compensation model 210.

In the illustrated example, each block 215 of the quantized model 125 has a corresponding block 220 in the compensation model 210, where intermediate features of each block 215 are used as input to the corresponding block 220, and the output of the corresponding block 220 is then provided as input to the next block 215 of the quantized model. As discussed above, although five blocks 215 and 220 are depicted for conceptual clarity, there may be any number of blocks 215 and 220 in the quantized model 125 and compensation model 210. Further, although the illustrated example depicts a corresponding block 220 for each block 215, in some aspects, the compensation model 210 may include blocks 220 only for a subset of the blocks 215, as discussed above. For example, if there is no block 220B in the compensation model 210 (e.g., the block 215B of the quantized model 125 has no corresponding block in the compensation model 210), the output of the block 215B may instead be provided directly to the block 215C.

In some aspects, for an architecture using the workflow 200C, the training system may train the compensation model 210 end-to-end and/or block-wise. In some aspects, to train the compensation model 210 end-to-end, the training system may update parameters of the blocks 220 (leaving the parameters of the blocks 215 unchanged) to seek to minimize (or at least reduce) the difference between the output 225 and a corresponding output that is generated when the input 205 is processed by the non-quantized baseline model, as discussed above. Similarly, to train the compensation model 210 block-wise, the training system may update the parameters of the blocks 220 to seek to minimize (or at least reduce) the difference between the output of each block 220 and the output of a corresponding block in the non-quantized baseline model.

In some aspects, as discussed above, the architectures discussed above with reference to the workflows 200A, 200B, and 200C may combined within a single compensated model. For example, one or more quantized blocks 215 of the quantized model 125 may use corresponding compensation blocks 220 of the compensation model 210 to process internal or intermediate features (as discussed with reference to FIG. 2A), the outputs of one or more quantized blocks 215 of the quantized model 125 may be aggregated with the output features of corresponding compensation blocks 220 of the compensation model 210 (as discussed with reference to FIG. 2B), and/or one or more quantized blocks 215 of the quantized model 125 may receive input from a compensation block 220, and provide output to a corresponding compensation block 220 of the compensation model 210 (as discussed with reference to FIG. 2C). Similarly, one or more quantized blocks 215 of the quantized model 125 may not have a corresponding compensation block 220 (e.g., the output of the block 215 may be provided directly as input to the subsequent block 215), and/or one or more additional compensation blocks 220 (without a corresponding quantized block 215) may be used (e.g., to generate the model output).

### Example Method for Compensating and Adapting Quantized Machine Learning Models

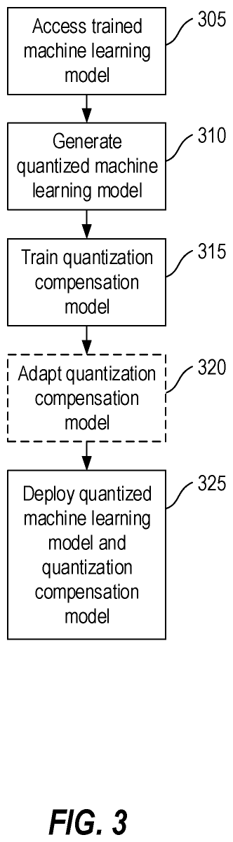

FIG. 3 is a flow diagram depicting an example method 300 for compensating and adapting quantized machine learning models, according to some aspects of the present disclosure. In some aspects, the method 300 is performed by one or more processing systems, such as the machine learning systems discussed above with reference to FIGS. 1, 2A, 2B, and/or 2C.

At block 305, the processing system accesses a trained machine learning model (e.g., the machine learning model 115 of FIG. 1). In some aspects, as discussed above, the processing system may train the machine learning model using training data. In other aspects, the processing system may access or receive a trained machine learning model from one or more other systems. The trained machine learning model generally comprises a set of parameters having values learned based on training data. For example, the machine learning model may correspond to a convolutional neural network (CNN) (e.g., for computer vision tasks), an LLM (e.g., for text generation tasks), and the like. In some aspects, the machine learning model is a relatively large model (e.g., having a large number of parameters encoded using a relatively high-precision format, such as sixteen bit).

At block 310, the processing system generates a quantized machine learning model (e.g., the quantized model 125 of FIGS. 1 and 2A-2C) by quantizing the trained machine learning model. In some aspects, as discussed above, the quantized machine learning model may generally have a relatively smaller size, as compared to the trained machine learning model. For example, the parameters of the quantized machine learning model may be encoded using a relatively lower-precision format, such as four-bit or eight-bit.

At block 315, the processing system trains a quantization compensation model (e.g., the compensation model 210 of FIGS. 2A-2C). In some aspects, as discussed above, the processing system trains the quantization compensation model based on the trained machine learning model and the quantized machine learning model, in an effort to make the outputs of the quantized model similar to the outputs of the trained model. In some aspects, as discussed above, the processing system uses non-labeled training data (e.g., the compensation data 130 of FIG. 1) to update the parameters of the compensation model, while the parameters of the trained machine learning model and the quantized machine learning model are kept fixed. In some aspects, as discussed above, the processing system trains the compensation model end-to-end. In some aspects, as discussed above, the processing system trains the compensation model in a block-wise fashion.

At block 320, the processing system optionally adapts the quantization compensation model to generate an adapted model (e.g., the adapted model 155 of FIG. 1), as discussed above. For example, as discussed above, the processing system may use labeled training data for a target domain (e.g., the adaptation data 145 of FIG. 1) to update the parameters of the quantization compensation model, while the parameters of the quantized machine learning model are kept fixed. In some aspects, as discussed above, the processing system adapts the compensation model end-to-end. In some aspects, as discussed above, the processing system trains the compensation model in a block-wise fashion.

At block 325, the processing system deploys the quantized machine learning model and the (potentially adapted) quantization compensation model (e.g., an ensemble comprising the quantized model and the compensation model) for inferencing. In some aspects, as discussed above, the different components of the compensated model may be implemented or deployed using different hardware components. For example, the quantized machine learning model may be processed using one hardware component (e.g., a graphics processing unit (GPU)), while the (potentially adapted) compensation model may be processed using a second hardware component (e.g., a central processing unit (CPU)).

### Example Method for Training Quantization Compensation Models

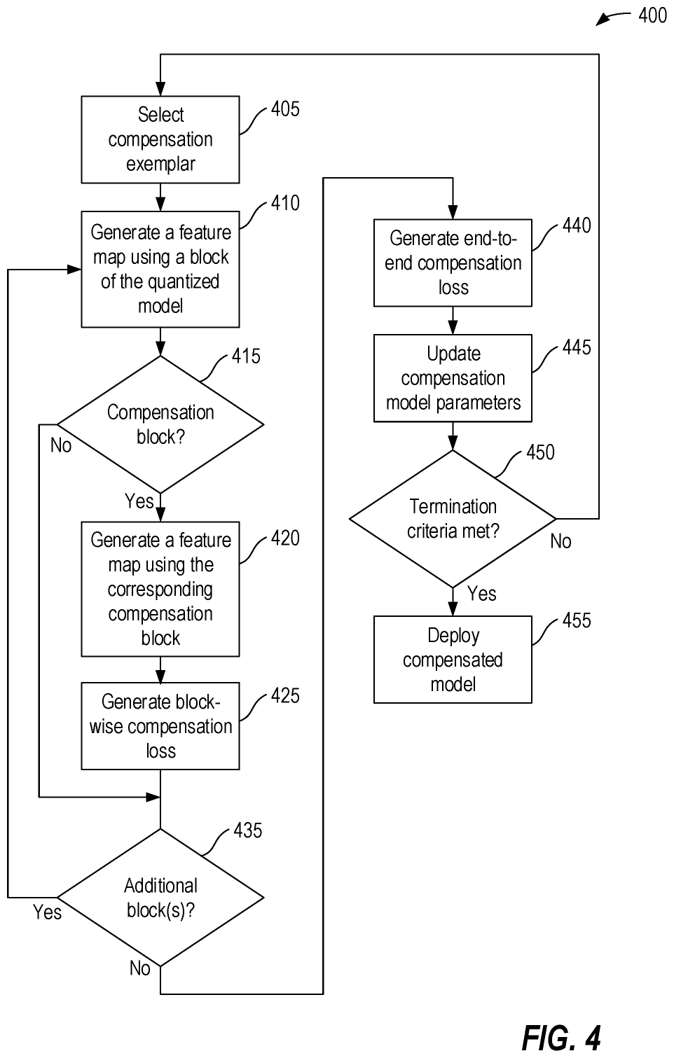

FIG. 4 is a flow diagram depicting an example method 400 for training quantization compensation models, according to some aspects of the present disclosure. In some aspects, the method 400 is performed by one or more processing systems, such as the machine learning systems discussed above with reference to FIGS. 1, 2A, 2B, 2C, and/or 3. In some aspects, the method 400 provides additional detail for the block 315 of FIG. 3.

At block 405, the processing system selects a compensation exemplar (e.g., an exemplar from the compensation data 130 of FIG. 1). Generally, the processing system may select the compensation exemplar using any suitable criteria, including randomly or pseudo-randomly. In some aspects, as discussed above, the compensation exemplar may generally correspond to the same domain as the data used to train the baseline model, but may lack ground-truth labels.

At block 410, the processing system generates a first feature map using a block of the quantized model (e.g., a block 215 of the quantized model 125 of FIGS. 2A-2C). In some aspects, the particular data processed to generate the feature map may vary depending on the particular implementation. For example, if the block is the first block in the quantized model, then the processing system may process the selected compensation exemplar using the block to generate the first feature map. If the block is an internal block of the quantized model, then the processing system may process a feature map generated by a prior component.

For example, if the compensated model uses the architecture discussed with reference to FIG. 2A, then the processing system may process the feature map generated by the prior block of the quantized model using the current block in order to generate the first feature map. As another example, if the compensated model uses the architecture discussed with reference to FIG. 2B, then the processing system may process the feature map generated by the prior aggregation operation (e.g., an aggregation operation 230) using the current block in order to generate the first feature map. As yet another example, if the compensated model uses the architecture discussed with reference to FIG. 2C, then the processing system may process the feature map generated by the prior block of the compensation model using the current block of the quantized model in order to generate the first feature map.

At block 415, the processing system determines whether there is a corresponding compensation block for the quantized block that was used, at block 410, to generate the first feature map. If not, then the method 400 proceeds to block 435. If there is a corresponding compensation block in the compensation model, then the method 400 continues to block 420.

At block 420, the processing system generates a second feature map using the corresponding block of the compensation model (e.g., a block 220 of the compensation model 210 of FIGS. 2A-2C). In some aspects, the particular data processed to generate the second feature map may vary depending on the particular implementation.

For example, if the compensated model uses the architecture discussed with reference to FIG. 2A, then the processing system may process an intermediate feature map generated by the corresponding block of the quantized model, as discussed above. As another example, if the compensated model uses the architecture discussed with reference to FIG. 2B, then the processing system may process the feature map generated by the prior aggregation operation (e.g., an aggregation operation 230) using the compensation block in order to generate the second feature map. As yet another example, if the compensated model uses the architecture discussed with reference to FIG. 2C, the processing system may process the feature map generated by the corresponding block of the quantized model (e.g., at block 410) using the compensation block in order to generate the second feature map.

At block 425, the processing system then optionally computes a block-wise compensation loss for the compensation model based on the first and second feature maps (generated at block 410 and 425, respectively). In some aspects, as discussed above, the compensation loss is generated based further on a feature map generated by the corresponding block in the non-quantized baseline model. For example, the processing system may compute a cross-entropy loss (or use any other suitable loss algorithm) based on the features. The method 400 then continues to block 435.

At block 435, the processing system determines whether there is at least one more block in the quantized model. If so, then the method 400 returns to block 410 to generate a new feature map using the next block in the quantized model. If no further blocks remain, then the method 400 continues to block 440.

At block 440, the processing system optionally generates an end-to-end compensation loss based on the output of the compensated model (e.g., the final output of the quantized model and/or the compensation model). In some aspects, as discussed above, the compensation loss is generated based further on the output generated by the non-quantized baseline model. For example, the processing system may compute a cross-entropy loss (or use any other suitable loss algorithm) based on the outputs. The method 400 then continues to block 445.

At block 445, the processing system updates one or more parameters of the compensation model (e.g., using backpropagation), as discussed above. In some aspects, the parameters of the quantized machine learning model (and the baseline model) are static and unchanged during this updating of the compensation model. Although the illustrated example depicts stochastic gradient descent for conceptual clarity (e.g., refining the compensation model based on each compensation exemplar individually), in some aspects, the processing system may additionally or alternatively use batch gradient descent.

At block 450, the processing system determines whether one or more termination criteria are satisfied. Generally, the termination criteria used may vary depending on the particular implementation. For example, in some aspects, the processing system may determine whether at least one compensation exemplar remains to be used, whether at least one epoch or iteration of training remains, whether a defined amount of time or computational resources have been spent training, whether the compensated model exhibits a minimum desired level of accuracy, and the like.

If the criteria are not met, then the method 400 returns to block 405. If the criteria are met, then the method 400 continues to block 455, where the processing system deploys the compensated model. As discussed above, deploying the compensated model may generally include any operations used to prepare or provide the model for inferencing, such as transmitting the parameters of the compensated model to an inferencing system, using one or more hardware components, and the like.

### Example Method for Adapting Quantization Compensation Models

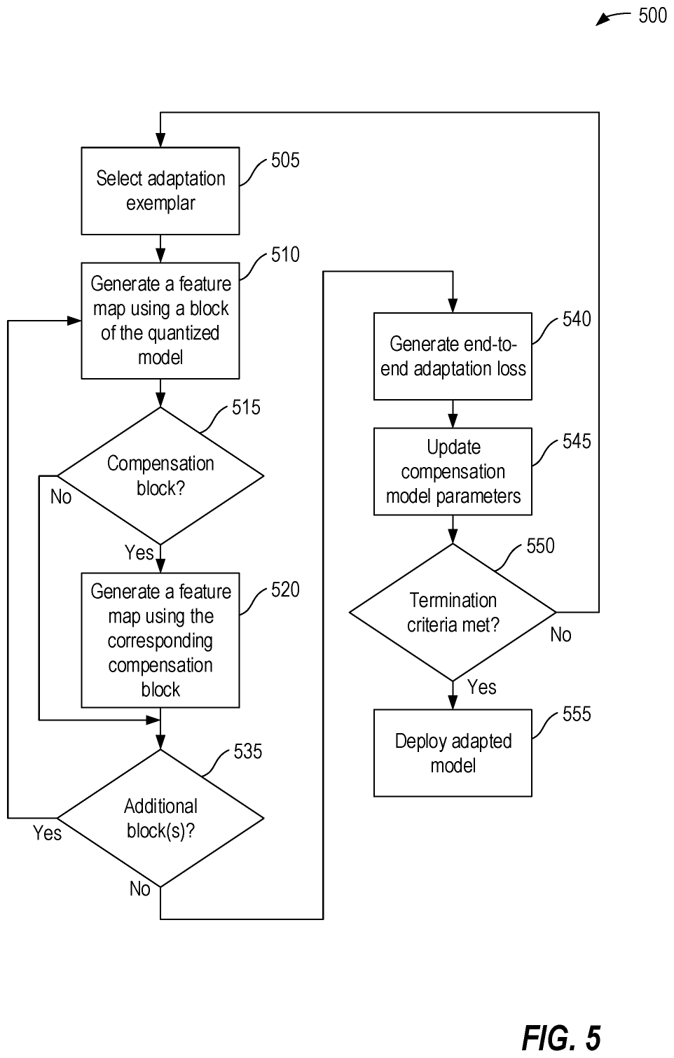

FIG. 5 is a flow diagram depicting an example method 500 for adapting quantization compensation models, according to some aspects of the present disclosure. In some aspects, the method 500 is performed by one or more processing systems, such as the machine learning systems discussed above with reference to FIGS. 1, 2A, 2B, 2C, 3, and/or 4. In some aspects, the method 500 provides additional detail for the block 320 of FIG. 3.

At block 505, the processing system selects an adaptation exemplar (e.g., an exemplar from the adaptation data 145 of FIG. 1). Generally, the processing system may select the adaptation exemplar using any suitable criteria, including randomly or pseudo-randomly. In some aspects, as discussed above, the adaptation exemplar may generally correspond to a target domain (e.g., data for a specific user or entity for which the model is being adapted), while the data used to train the baseline model may correspond to a source domain. In some aspects, the adaptation exemplar may have one or more ground-truth labels.

At block 510, the processing system generates a first feature map using a block of the quantized model (e.g., a block 215 of the quantized model 125 of FIGS. 2A-2C). In some aspects, the particular data processed to generate the feature map may vary depending on the particular implementation. For example, if the block is the first block in the quantized model, the processing system may process the selected adaptation exemplar using the block to generate the first feature map. If the block is an internal block of the quantized model, the processing system may process a feature map generated by a prior component.

For example, if the compensated model uses the architecture discussed with reference to FIG. 2A, then the processing system may process the feature map generated by the prior block of the quantized model using the current block in order to generate the first feature map. As another example, if the compensated model uses the architecture discussed with reference to FIG. 2B, then the processing system may process the feature map generated by the prior aggregation operation (e.g., an aggregation operation 230) using the current block in order to generate the first feature map. As yet another example, if the compensated model uses the architecture discussed with reference to FIG. 2C, then the processing system may process the feature map generated by the prior block of the compensation model using the current block of the quantized model in order to generate the first feature map.

At block 515, the processing system determines whether there is a corresponding compensation block for the quantized block that was used, at block 510, to generate the first feature map. If not, then the method 500 proceeds to block 535. If there is a corresponding compensation block in the compensation model, then the method 500 continues to block 520.

At block 520, the processing system generates a second feature map using the corresponding block of the compensation model (e.g., a block 220 of the compensation model 210 of FIGS. 2A-2C). In some aspects, the particular data processed to generate the second feature map may vary depending on the particular implementation.

For example, if the compensated model uses the architecture discussed with reference to FIG. 2A, then the processing system may process an intermediate feature map generated by the corresponding block of the quantized model, as discussed above. As another example, if the compensated model uses the architecture discussed with reference to FIG. 2B, then the processing system may process the feature map generated by the prior aggregation operation (e.g., an aggregation operation 230) using the compensation block in order to generate the second feature map. As yet another example, if the compensated model uses the architecture discussed with reference to FIG. 2C, the processing system may process the feature map generated by the corresponding block of the quantized model (e.g., at block 510) using the compensation block in order to generate the second feature map.

At block 535, the processing system determines whether there is at least one more block in the quantized model. If so, then the method 500 returns to block 510 to generate a new feature map using the next block in the quantized model. If no further blocks remain, then the method 500 continues to block 540.

At block 540, the processing system optionally generates an end-to-end adaptation loss based on the output of the compensated model (e.g., the final output of the quantized model and/or the compensation model). In some aspects, as discussed above, the adaptation loss is generated based further on the ground truth label(s) of the selected adaptation exemplar. For example, the processing system may compute a cross-entropy loss (or use any other suitable loss algorithm) based on the output and the ground-truth. The method 500 then continues to block 545.

At block 545, the processing system updates one or more parameters of the compensation model (e.g., using backpropagation), as discussed above. In some aspects, the parameters of the quantized machine learning model are static and unchanged during this updating of the compensation model. Although the illustrated example depicts stochastic gradient descent for conceptual clarity (e.g., refining the compensation model based on each adaptation exemplar individually), in some aspects, the processing system may additionally or alternatively use batch gradient descent.

At block 550, the processing system determines whether one or more termination criteria are satisfied. Generally, the termination criteria used may vary depending on the particular implementation. For example, in some aspects, the processing system may determine whether at least one adaptation exemplar remains to be used, whether at least one epoch or iteration of training remains, whether a defined amount of time or computational resources have been spent training, whether the compensated model exhibits a minimum desired level of accuracy, and the like.

If the criteria are not met, then the method 500 returns to block 505. If the criteria are met, then the method 500 continues to block 555, where the processing system deploys the adapted model. As discussed above, deploying the adapted model may generally include any operations used to prepare or provide the model for inferencing, such as transmitting the parameters of the adapted model to an inferencing system, using one or more hardware components, and the like.

Although the illustrated method 500 depicts adapting the compensation model using end-to-end loss, in some aspects, the processing system may additionally or alternatively train the adaptation model using block-wise losses, as discussed above.

### Example Method for Generating Output Using Quantization-Compensated Machine Learning Models

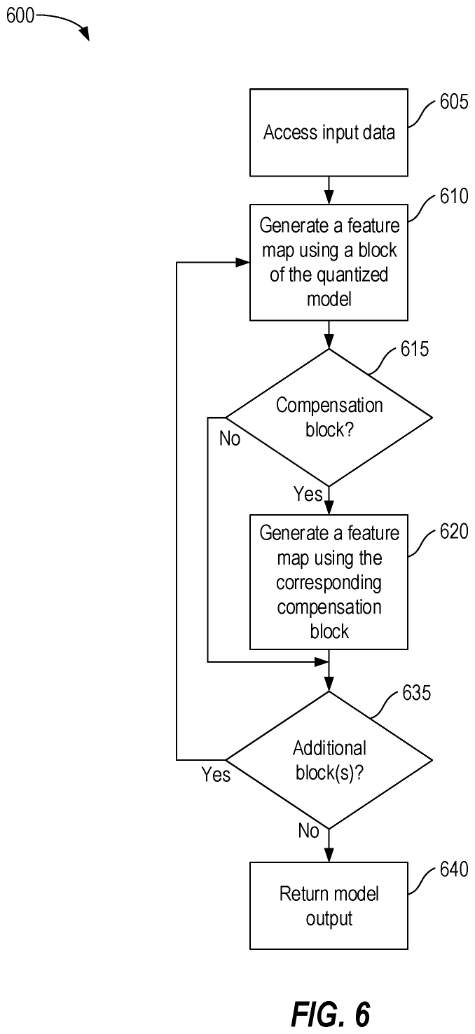

FIG. 6 is a flow diagram depicting an example method 600 for generating output using quantization-compensated machine learning models, according to some aspects of the present disclosure. In some aspects, the method 600 is performed by one or more processing systems, such as the machine learning systems discussed above with reference to FIGS. 1, 2A, 2B, 2C, 3, 4, and/or 5.

At block 605, the processing system accesses input data (e.g., the input 205 of FIGS. 2A-2C). In some aspects, the input data lacks ground-truth, and is accessed in order to be processed to generate a prediction (e.g., a continuous or categorical value). In some aspects, the input data corresponds to a target domain (e.g., if the compensated model has been adapted to the target domain).

At block 610, the processing system generates a first feature map using a block of the quantized model (e.g., a block 215 of the quantized model 125 of FIGS. 2A-2C). In some aspects, the particular data processed to generate the feature map may vary depending on the particular implementation. For example, if the block is the first block in the quantized model, then the processing system may process the input data using the block to generate the first feature map. If the block is an internal block of the quantized model, then the processing system may process a feature map generated by a prior component.

For example, if the compensated model uses the architecture discussed with reference to FIG. 2A, then the processing system may process the feature map generated by the prior block of the quantized model using the current block in order to generate the first feature map. As another example, if the compensated model uses the architecture discussed with reference to FIG. 2B, then the processing system may process the feature map generated by the prior aggregation operation (e.g., an aggregation operation 230) using the current block in order to generate the first feature map. As yet another example, if the compensated model uses the architecture discussed with reference to FIG. 2C, then the processing system may process the feature map generated by the prior block of the compensation model using the current block of the quantized model in order to generate the first feature map.

At block 615, the processing system determines whether there is a corresponding compensation block for the quantized block that was used, at block 610, to generate the first feature map. If not, then the method 600 proceeds to block 635. If there is a corresponding compensation block in the compensation model, then the method 600 continues to block 620.

At block 620, the processing system generates a second feature map using the corresponding block of the compensation model (e.g., a block 220 of the compensation model 210 of FIGS. 2A-2C). In some aspects, the particular data processed to generate the second feature map may vary depending on the particular implementation.

For example, if the compensated model uses the architecture discussed with reference to FIG. 2A, then the processing system may process an intermediate feature map generated by the corresponding block of the quantized model, as discussed above. As another example, if the compensated model uses the architecture discussed with reference to FIG. 2B, then the processing system may process the feature map generated by the prior aggregation operation (e.g., an aggregation operation 230) using the compensation block in order to generate the second feature map. As yet another example, if the compensated model uses the architecture discussed with reference to FIG. 2C, then the processing system may process the feature map generated by the corresponding block of the quantized model (e.g., at block 610) using the compensation block in order to generate the second feature map.

At block 635, the processing system determines whether there is at least one more block in the quantized model. If so, then the method 600 returns to block 610 to generate a new feature map using the next block in the quantized model. If no further blocks remain, then the method 600 continues to block 640.

At block 640, the processing system returns the model output as the prediction for the input data. Generally, returning the model output may include providing the model output to the entity (e.g., application) that provided the input data and/or requested the prediction be generated, outputting the prediction for display, outputting the prediction to a downstream component or system, and the like.

### Example Method for Using Machine Learning Models to Compensate for Quantization

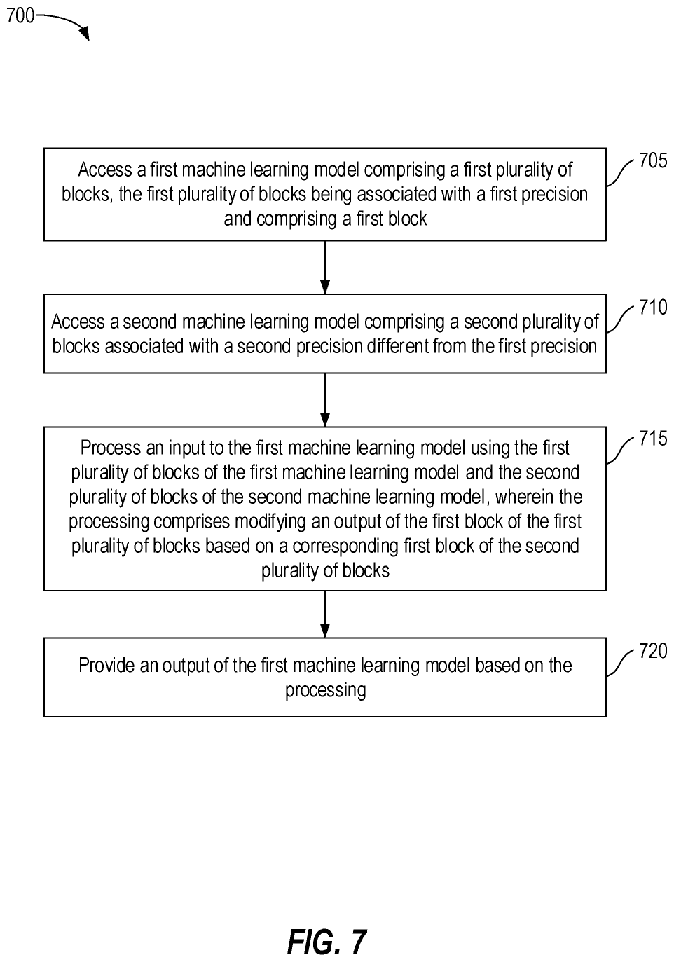

FIG. 7 is a flow diagram depicting an example method 700 for using machine learning models to compensate, or at least adjust, for quantization, according to some aspects of the present disclosure. In some aspects, the method 700 is performed by one or more processing systems, such as the machine learning systems discussed above with reference to FIGS. 1, 2A, 2B, 2C, 3, 4, 5, and/or 6.

At block 705, a first machine learning model comprising a first plurality of blocks is accessed. The first plurality of blocks is associated with a first precision and comprises a first block.

At block 710, a second machine learning model comprising a second plurality of blocks associated with a second precision different from the first precision, is accessed. In some aspects, the second plurality of blocks comprises a first block, and the first block of the second plurality of blocks corresponds to the first block of the first plurality of blocks.

In some aspects, the second precision is higher than the first precision. In some aspects, the second precision corresponds to a 16-bit bit width, and the first precision corresponds to a 4-bit bit width.

In some aspects, the first machine learning model has a first size, the second machine learning model has a second size, and the second size is smaller than the first size.

In some aspects, the first machine learning model was generated by quantizing a baseline machine learning model having a baseline precision higher than the first precision. In this case, the second machine learning model may have been trained to adjust for quantization errors resulting from the quantization of the baseline machine learning model.

At block 715, an input to the first machine learning model is processed using the first plurality of blocks of the first machine learning model and the second plurality of blocks of the second machine learning model. This processing may involve modifying an output of the first block of the first plurality of blocks based on a corresponding first block of the second plurality of blocks.

In some aspects, the first plurality of blocks comprises an ordered network of blocks, and the first plurality of blocks may further comprise a second block configured to receive as an input the modified output of the first block of the first plurality of blocks and to process the received input. In such aspects, the processing of the input using the first machine learning model may further include modifying an output of the second block of the first plurality of blocks using a corresponding second block of the second plurality of blocks.

At block 720, an output of the first machine learning model is provided based on the processing.

In some aspects, the first machine learning model is accessed by a first circuit of an IC device, and the second machine learning model is accessed by a second circuit of the IC device different from the first circuit.

In some aspects, the first machine learning model was trained based on training data from a source domain, the second machine learning model was trained using adjustment data from the source domain, and the second machine learning model was trained without using labels for the adjustment data.

In some aspects, training the second machine learning model comprises generating an adjustment loss for a first block of the second machine learning model based on (i) a first feature map generated by a first block of a baseline machine learning model based on a first exemplar in the adjustment data, (ii) a second feature map generated by a quantized version of the first block of the baseline machine learning model based on the first exemplar, the quantized version corresponding to the first block of the first plurality of blocks, and (iii) a third feature map generated by the first block of the second plurality of blocks based on the first exemplar.

In some aspects, training the second machine learning model comprises generating an adjustment loss for a first block of the second plurality of blocks based on (i) a first model output generated by a baseline machine learning model based on a first exemplar in the adjustment data, (ii) a second model output generated by the first machine learning model based on the first exemplar, and (iii) a third model output generated by the second machine learning model based on the first exemplar.

In some aspects, the method 700 further includes adapting the second machine learning model to a target domain based on labeled adaptation data for the target domain. The first machine learning model may be frozen during adaptation to the target domain.

### Example Method for Training Machine Learning Models to Compensate for Quantization

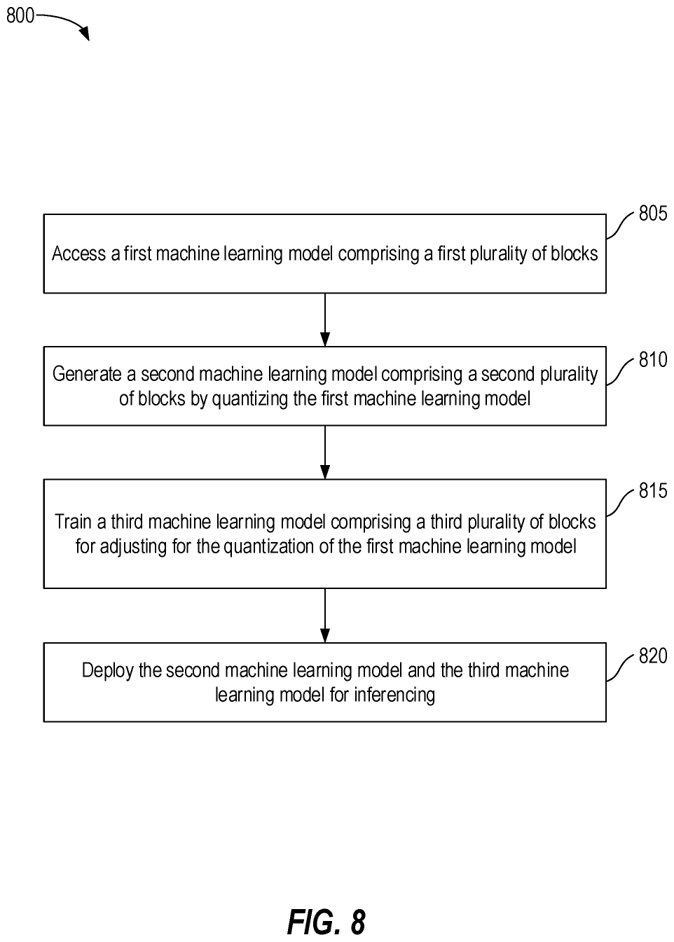

FIG. 8 is a flow diagram depicting an example method 800 for training machine learning models to compensate, or at least adjust, for quantization, according to some aspects of the present disclosure. In some aspects, the method 800 is performed by one or more processing systems, such as the machine learning systems discussed above with reference to FIGS. 1, 2A, 2B, 2C, 3, 4, 5, 6, and/or 7.

At block 805, a first machine learning model comprising a first plurality of blocks is accessed.

In some aspects, each of the first plurality of blocks comprises at least one of a layer of the first machine learning model or a transformer of the first machine learning model.

At block 810, a second machine learning model comprising a second plurality of blocks is generated by quantizing the first machine learning model.

At block 815, a third machine learning model comprising a third plurality of blocks is trained for adjusting for the quantization of the first machine learning model.

In some aspects, the first machine learning model was trained based on training data from a source domain, the third machine learning model is trained using adjustment data from the source domain, and the third machine learning model is trained without using labels for the adjustment data.

In some aspects, training the third machine learning model comprises generating an adjustment loss for a first block of the third plurality of blocks based on (i) a first feature map generated by a first block of the first plurality of blocks based on a first exemplar in the adjustment data, (ii) a second feature map generated by a first block of the second plurality of blocks based on the first exemplar, wherein the first block from the second plurality of blocks comprises a quantized version of the first block from the first plurality of blocks, and (iii) a third feature map generated by the first block of the third plurality of blocks based on the first exemplar, wherein the first block of the third plurality of blocks corresponds to the first block of the second plurality of blocks.

In some aspects, training the third machine learning model comprises generating an adjustment loss for a first block of the third plurality of blocks based on(i) a first model output generated by the first machine learning model based on a first exemplar in the adjustment data, (ii) a second model output generated by the second machine learning model based on the first exemplar, and (iii) a third model output generated by the third machine learning model based on the first exemplar.

In some aspects, parameters of the second machine learning model are encoded using a first value representation, parameters of the third machine learning model are encoded using a second value representation, and the second value representation has a higher precision than the first value representation.

At block 820, the second machine learning model and the third machine learning model are deployed for inferencing.

In some aspects, the method 800 further includes adapting the third machine learning model to a target domain based on labeled adaptation data for the target domain, wherein the second machine learning model is frozen during adaptation to the target domain.

In some aspects, deploying the second machine learning model and the third machine learning model for inferencing comprises deploying the second machine learning model to be executed on a first hardware component and deploying the third machine learning model to be executed on a second hardware component.

### Example Processing System for Machine Learning

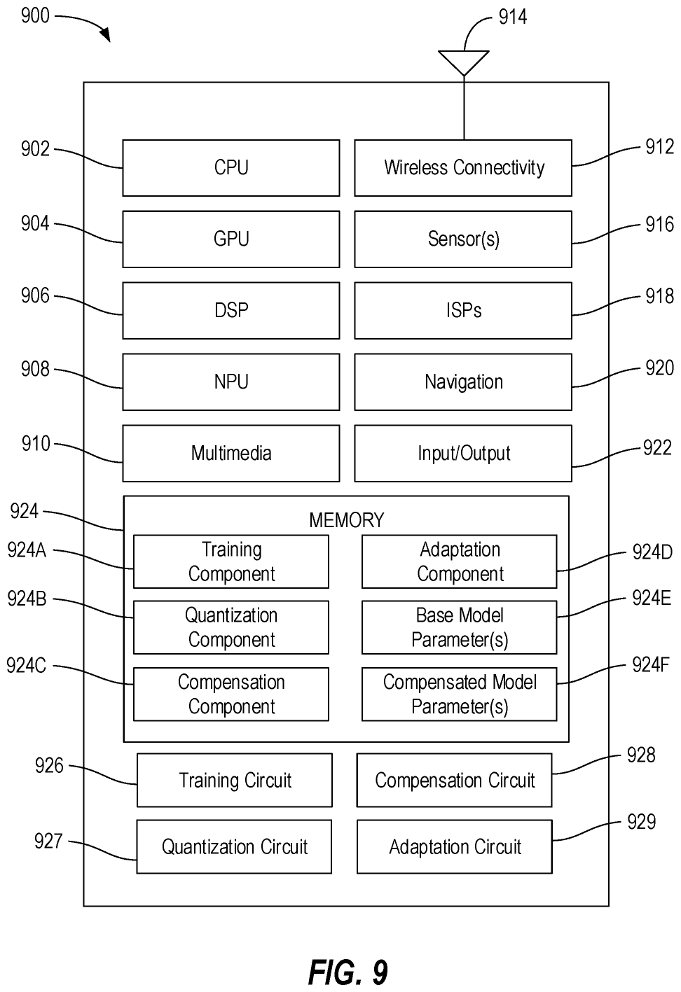

FIG. 9 depicts an example processing system 900 configured to perform various aspects of the present disclosure, including, for example, the techniques and methods described with respect to FIGS. 1-8. In some aspects, the processing system 900 may correspond to a training system. For example, the processing system 900 may correspond to a device trains machine learning models, quantizes machine learning models, trains compensation machine learning models, adapts compensation machine learning models, and/or uses compensated and/or adapted machine learning models for inferencing. Although depicted as a single system for conceptual clarity, in some aspects, as discussed above, the operations described below with respect to the processing system 900 may be distributed across any number of devices or systems.

The processing system 900 includes a central processing unit (CPU) 902, which in some examples may be a multi-core CPU. Instructions executed at the CPU 902 may be loaded, for example, from a program memory associated with the CPU 902 or may be loaded from a memory partition (e.g., a partition of a memory 924).

The processing system 900 also includes additional processing components tailored to specific functions, such as a graphics processing unit (GPU) 904, a digital signal processor (DSP) 906, a neural processing unit (NPU) 908, a multimedia component 910 (e.g., a multimedia processing unit), and a wireless connectivity component 912.

An NPU, such as the NPU 908, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 908, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 908 is a part of one or more of the CPU 902, the GPU 904, and/or the DSP 906.

In some examples, the wireless connectivity component 912 may include subcomponents, for example, for third generation (3G) connectivity, fourth generation (4G) connectivity (e.g., Long-Term Evolution LTE), fifth generation (5G) connectivity (e.g., New Radio (NR)), Wi-Fi connectivity, Bluetooth connectivity, and other wireless data transmission standards. The wireless connectivity component 912 is further connected to one or more antennas 914.

The processing system 900 may also include one or more sensor processing units 916 associated with any manner of sensor, one or more image signal processors (ISPs) 918 associated with any manner of image sensor, and/or a navigation processor 920, which may include satellite-based positioning system components (e.g., GPS or GLONASS) as well as inertial positioning system components.

The processing system 900 may also include one or more input and/or output devices 922, such as screens, touch-sensitive surfaces (including touch-sensitive displays), physical buttons, speakers, microphones, and the like.

In some examples, one or more of the processors of the processing system 900 may be based on an ARM or RISC-V instruction set.

The processing system 900 also includes a memory 924, which is representative of one or more static and/or dynamic memories, such as a dynamic random access memory, a flash-based static memory, and the like. In this example, the memory 924 includes computer-executable components, which may be executed by one or more of the aforementioned processors of the processing system 900.

In particular, in this example, the memory 924 includes a training component 924A, a quantization component 924B, a compensation component 924C, and an adaptation component 924D. Although not depicted in the illustrated example, the memory 924 may also include other components, such as an inferencing component to generate output predictions based on processing model input using compensated machine learning models, as discussed above. Though depicted as discrete components for conceptual clarity in FIG. 9, the illustrated components (and others not depicted) may be collectively or individually implemented in various aspects.

As illustrated, the memory 924 also includes a set of base model parameters 924E (e.g., parameters of a baseline machine learning model, such as the machine learning model 115 of FIG. 1) and a set of compensated model parameters 924F (e.g., parameters of the compensated model 140 and/or the adapted model 155 of FIG. 1). Although not depicted in the illustrated example, the memory 924 may also include other data such as training data (e.g., the training data 105 of FIG. 1), compensation data (e.g., the compensation data 130 of FIG. 1), and/or adaptation data (e.g., the adaptation data 145 of FIG. 1).

Processing system 900 further comprises a training circuit 926, a quantization circuit 927, a compensation circuit 928, and an adaptation circuit 929. The depicted circuits, and others not depicted (such as an inferencing circuit), may be configured to perform various aspects of the techniques described herein.

The training component 924A and/or the training circuit 926 (which may correspond to the training component 110 of FIG. 1) may be used to train a baseline machine learning model (e.g., to learn the base model parameters 924E), as discussed above. For example, the training component 924A and/or the training circuit 926 may use training data to learn parameters that are encoded in a relatively high-precision format, such as a sixteen-bit representation.

The quantization component 924B and/or the quantization circuit 927 (which may correspond to the quantization component 120 of FIG. 1) may be used to quantize the trained baseline machine learning model (e.g., to generate the quantized model 125 of FIGS. 1 and 2A-2C), as discussed above. For example, the quantization component 924B and/or the quantization circuit 927 may quantize the model to generate a set of parameters that are encoded in a relatively lower-precision format, such as a four-bit representation.

The compensation component 924C and/or the compensation circuit 928 (which may correspond to the compensation component 135 of FIG. 1) may be used to train a compensation model (e.g., the compensation model 210 of FIGS. 2A-2C), as discussed above. For example, the compensation component 924C and/or the compensation circuit 928 may use compensation data to learn parameters for the compensation model. In some aspects, as discussed above, the parameters of the compensation model are encoded in a relatively high-precision format, such as a sixteen-bit representation.

The adaptation component 924D and/or the adaptation circuit 929 (which may correspond to the adaptation component 150 of FIG. 1) may be used to adapt the compensated model (e.g., to generate the adapted model 155 of FIG. 1), as discussed above. For example, the adaptation component 924D and/or the adaptation circuit 929 may use adaptation data to update or refine the parameters of the compensation model.

Though depicted as separate components and circuits for clarity in FIG. 9, the training circuit 926, the quantization circuit 927, the compensation circuit 928, and the adaptation circuit 929 may collectively or individually be implemented in other processing devices of the processing system 900, such as within the CPU 902, the GPU 904, the DSP 906, the NPU 908, and the like.

Generally, the processing system 900 and/or components thereof may be configured to perform the methods described herein.

Notably, in other aspects, aspects of the processing system 900 may be omitted, such as where the processing system 900 is a server computer or the like. For example, the multimedia component 910, the wireless connectivity component 912, the sensor processing units 916, the ISPs 918, and/or the navigation processor 920 may be omitted in other aspects. Further, aspects of the processing system 900 maybe distributed between multiple devices.

### Example Clauses

Implementation examples are described in the following numbered clauses:

Clause 1: A method, comprising: accessing a first machine learning model comprising a first plurality of blocks, the first plurality of blocks being associated with a first precision and comprising a first block; accessing a second machine learning model comprising a second plurality of blocks associated with a second precision different from the first precision, wherein: the second plurality of blocks comprises a first block; and the first block of the second plurality of blocks corresponds to the first block of the first plurality of blocks; processing an input to the first machine learning model using the first plurality of blocks of the first machine learning model and the second plurality of blocks of the second machine learning model, wherein the processing comprises modifying an output of the first block of the first plurality of blocks based on the corresponding first block of the second plurality of blocks; and providing an output of the first machine learning model based on the processing.

Clause 2: A method according to Clause 1, wherein the second precision is higher than the first precision.

Clause 3: A method according to Clause 2, wherein the second precision corresponds to a 16-bit bit width and the first precision corresponds to a 4-bit bit width.

Clause 4: A method according to any of Clauses 1-3, wherein: the first machine learning model has a first size, the second machine learning model has a second size, and the second size is smaller than the first size.

Clause 5: A method according to any of Clauses 1-4, wherein: the first machine learning model is accessed by a first circuit of an integrated-circuit (IC) device, and the second machine learning model is accessed by a second circuit of the IC device different from the first circuit.

Clause 6: A method according to any of Clauses 1-5, wherein: the first machine learning model was generated by quantizing a baseline machine learning model having a baseline precision higher than the first precision, and the second machine learning model was trained to adjust for quantization errors resulting from the quantization of the baseline machine learning model.

Clause 7: A method according to any of Clauses 1-6, wherein: the first plurality of blocks comprises an ordered network of blocks, the first plurality of blocks further comprises a second block configured to receive as an input the modified output of the first block of the first plurality of blocks and to process the received input, and the processing of the input using the quantized machine learning model further comprises modifying an output of the second block of the first plurality of blocks using a corresponding second block of the second plurality of blocks.

Clause 8: A method according to any of Clauses 1-7, wherein: the first machine learning model was trained based on training data from a source domain, the second machine learning model was trained using adjustment data from the source domain, and the second machine learning model was trained without using labels for the adjustment data.

Clause 9: A method according to Clause 8, wherein training the second machine learning model comprises generating an adjustment loss for a first block of the second machine learning model based on: (i) a first feature map generated by a first block of a baseline machine learning model based on a first exemplar in the adjustment data, (ii) a second feature map generated by a quantized version of the first block of the baseline machine learning model based on the first exemplar, the quantized version corresponding to the first block of the first plurality of blocks, and (iii) a third feature map generated by the first block of the second plurality of blocks based on the first exemplar.

Clause 10: A method according to any of Clauses 8-9, wherein training the second machine learning model comprises generating an adjustment loss for a first block of the second plurality of blocks based on: (i) a first model output generated by a baseline machine learning model based on a first exemplar in the adjustment data, (ii) a second model output generated by the first machine learning model based on the first exemplar, and (iii) a third model output generated by the second machine learning model based on the first exemplar.

Clause 11: A method according to any of Clauses 8-10, further comprising adapting the second machine learning model to a target domain based on labeled adaptation data for the target domain, wherein the first machine learning model is frozen during adaptation to the target domain.

Clause 12: A method, comprising: accessing a first machine learning model comprising a first plurality of blocks; generating a second machine learning model comprising a second plurality of blocks by quantizing the first machine learning model; training a third machine learning model comprising a third plurality of blocks for adjusting for the quantization of the first machine learning model; and deploying the second machine learning model and the third machine learning model for inferencing.

Clause 13: A method according to Clause 12, wherein each of the first plurality of blocks comprises at least one of a layer of the first machine learning model or a transformer of the first machine learning model.

Clause 14: A method according to any of Clauses 12-13, wherein: the first machine learning model was trained based on training data from a source domain, the third machine learning model is trained using adjustment data from the source domain, and the third machine learning model is trained without using labels for the adjustment data.

Clause 15: A method according to Clause 14, wherein training the third machine learning model comprises generating an adjustment loss for a first block of the third plurality of blocks based on: (i) a first feature map generated by a first block of the first plurality of blocks based on a first exemplar in the adjustment data, (ii) a second feature map generated by a first block of the second plurality of blocks based on the first exemplar, wherein the first block from the second plurality of blocks comprises a quantized version of the first block from the first plurality of blocks, and (iii) a third feature map generated by the first block of the third plurality of blocks based on the first exemplar, wherein the first block of the third plurality of blocks corresponds to the first block of the second plurality of blocks.

Clause 16: A method according to any of Clauses 14-15, wherein training the third machine learning model comprises generating an adjustment loss for a first block of the third plurality of blocks based on: (i) a first model output generated by the first machine learning model based on a first exemplar in the adjustment data, (ii) a second model output generated by the second machine learning model based on the first exemplar, and (iii) a third model output generated by the third machine learning model based on the first exemplar.

Clause 17: A method according to any of Clauses 12-16, further comprising adapting the third machine learning model to a target domain based on labeled adaptation data for the target domain, wherein the second machine learning model is frozen during adaptation to the target domain.

Clause 18: A method according to any of Clauses 12-17, wherein: parameters of the second machine learning model are encoded using a first value representation, parameters of the third machine learning model are encoded using a second value representation, and the second value representation has a higher precision than the first value representation.

Clause 19: A method according to any of Clauses 12-18, wherein deploying the second machine learning model and the third machine learning model for inferencing comprises deploying the second machine learning model to be executed on a first hardware component and deploying the third machine learning model to be executed on a second hardware component.

Clause 20: A processing system comprising: a memory comprising computer-executable instructions; and one or more processors configured to execute the computer-executable instructions and cause the processing system to perform a method in accordance with any of Clauses 1-19.

Clause 21: A processing system comprising means for performing a method in accordance with any of Clauses 1-19.

Clause 22: A non-transitory computer-readable medium comprising computer-executable instructions that, when executed by one or more processors of a processing system, cause the processing system to perform a method in accordance with any of Clauses 1-19.

Clause 23: A computer program product embodied on a computer-readable storage medium comprising code for performing a method in accordance with any of Clauses 1-19.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system comprising:
one or more memories comprising computer-executable instructions; and
one or more processors configured to execute the computer-executable instructions and cause the processing system to:
access a first machine learning model comprising a first plurality of blocks, the first plurality of blocks being associated with a first precision and comprising a first block;
access a second machine learning model comprising a second plurality of blocks associated with a second precision different from the first precision, wherein:
the second plurality of blocks comprises a first block; and
the first block of the second plurality of blocks corresponds to the first block of the first plurality of blocks;
process an input to the quantized machine learning model using the first plurality of blocks of the first machine learning model and the second plurality of blocks of the second machine learning model, wherein, to process the input, the one or more processors are configured to execute the computer-executable instructions and cause the processing system to modify an output of the first block of the first plurality of blocks based on the corresponding first block of the second plurality of blocks; and
provide an output of the first machine learning model based on the processing.

2. The processing system of claim 1, wherein the second precision is higher than the first precision.

3. The processing system of claim 2, wherein the second precision corresponds to a 16-bit bit width and wherein the first precision corresponds to a 4-bit bit width.

4. The processing system of claim 1, wherein:
the first machine learning model has a first size;
the second machine learning model has a second size; and
the second size is smaller than the first size.

5. The processing system of claim 1, wherein:
the first machine learning model is accessed by a first circuit of an integrated-circuit (IC) device; and
the second machine learning model is accessed by a second circuit of the IC device different from the first circuit.

6. The processing system of claim 1, wherein:
the first machine learning model was generated by quantizing a baseline machine learning model having a baseline precision higher than the first precision, and
the second machine learning model was trained to adjust for quantization errors resulting from the quantization of the baseline machine learning model.

7. The processing system of claim 1, wherein:
the first plurality of blocks comprises an ordered network of blocks,
the first plurality of blocks further comprises a second block configured to receive as an input the modified output of the first block of the first plurality of blocks and to process the received input, and
to process the input, the one or more processors are configured to further execute the computer-executable instructions and cause the processing system to modify an output of the second block of the first plurality of blocks using a corresponding second block of the second plurality of blocks.

8. The processing system of claim 1, wherein:
the first machine learning model was trained based on training data from a source domain,
the second machine learning model was trained using adjustment data from the source domain, and
the second machine learning model was trained without using labels for the adjustment data.

9. The processing system of claim 8, wherein, to train the second machine learning model, the one or more processors are configured to execute the computer-executable instructions and cause the processing system to generate an adjustment loss for a first block of the second machine learning model based on:
(i) a first feature map generated by a first block of a baseline machine learning model based on a first exemplar in the adjustment data;
(ii) a second feature map generated by a quantized version of the first block of the baseline machine learning model based on the first exemplar, the quantized version corresponding to the first block of the first plurality of blocks; and
(iii) a third feature map generated by the first block of the second plurality of blocks based on the first exemplar.

10. The processing system of claim 8, wherein to train the second machine learning model, the one or more processors are configured to execute the computer-executable instructions and cause the processing system to generate an adjustment loss for a first block of the second plurality of blocks based on:
(i) a first model output generated by a baseline machine learning model based on a first exemplar in the adjustment data;
(ii) a second model output generated by the first machine learning model based on the first exemplar; and
(iii) a third model output generated by the second machine learning model based on the first exemplar.

11. The processing system of claim 8, wherein:
the one or more processors are configured to further execute the computer-executable instructions and cause the processing system to adapt the second machine learning model to a target domain based on labeled adaptation data for the target domain, and
the first machine learning model is frozen during adaptation to the target domain.

12. A processor-implemented method, comprising:
accessing a first machine learning model comprising a first plurality of blocks, the first plurality of blocks being associated with a first precision and comprising a first block;
accessing a second machine learning model comprising a second plurality of blocks associated with a second precision different from the first precision, wherein:
the second plurality of blocks comprises a first block; and
the first block of the second plurality of blocks corresponds to the first block of the first plurality of blocks;
processing an input to the first machine learning model using the first plurality of blocks of the first machine learning model and the second plurality of blocks of the second machine learning model, wherein the processing comprises modifying an output of the first block of the first plurality of blocks based on the corresponding first block of the second plurality of blocks; and
providing an output of the first machine learning model based on the processing.

13. The processor-implemented method of claim 12, wherein the second precision is higher than the first precision.

14. The processor-implemented method of claim 13, wherein the second precision corresponds to a 16-bit bit width and wherein the first precision corresponds to a 4-bit bit width.

15. The processor-implemented method of claim 12, wherein:
the first machine learning model has a first size;
the second machine learning model has a second size; and
the second size is smaller than the first size.

16. The processor-implemented method of claim 12, wherein:
the first machine learning model is accessed by a first circuit of an integrated-circuit (IC) device; and
the second machine learning model is accessed by a second circuit of the IC device different from the first circuit.

17. The processor-implemented method of claim 12, wherein:
the first machine learning model was generated by quantizing a baseline machine learning model having a baseline precision higher than the first precision, and
the second machine learning model was trained to adjust for quantization errors resulting from the quantization of the baseline machine learning model.

18. The processor-implemented method of claim 12, wherein:
the first plurality of blocks comprises an ordered network of blocks,
the first plurality of blocks further comprises a second block configured to receive as an input the modified output of the first block of the first plurality of blocks and to process the received input, and
the processing of the input using the first machine learning model further comprises modifying an output of the second block of the first plurality of blocks using a corresponding second block of the second plurality of blocks.

19. The processor-implemented method of claim 12, wherein:
the first machine learning model was trained based on training data from a source domain,
the second machine learning model was trained using adjustment data from the source domain, and
the second machine learning model was trained without using labels for the adjustment data.

20. The processor-implemented method of claim 19, wherein training the second machine learning model comprises generating an adjustment loss for a first block of the second machine learning model based on:
(i) a first feature map generated by a first block of a baseline machine learning model based on a first exemplar in the adjustment data;
(ii) a second feature map generated by a quantized version of the first block of the baseline machine learning model based on the first exemplar, the quantized version corresponding to the first block of the first plurality of blocks; and
(iii) a third feature map generated by the first block of the second plurality of blocks based on the first exemplar.

21. The processor-implemented method of claim 19, wherein training the second machine learning model comprises generating an adjustment loss for a first block of the second plurality of blocks based on:
(i) a first model output generated by a baseline machine learning model based on a first exemplar in the adjustment data;
(ii) a second model output generated by the first machine learning model based on the first exemplar; and
(iii) a third model output generated by the second machine learning model based on the first exemplar.

22. The processor-implemented method of claim 19, further comprising adapting the second machine learning model to a target domain based on labeled adaptation data for the target domain, wherein the first machine learning model is frozen during adaptation to the target domain.

23. A processor-implemented method, comprising:
accessing a first machine learning model comprising a first plurality of blocks;
generating a second machine learning model comprising a second plurality of blocks by quantizing the first machine learning model;
training a third machine learning model comprising a third plurality of blocks for adjusting for the quantization of the first machine learning model; and
deploying the second machine learning model and the third machine learning model for inferencing.

24. The processor-implemented method of claim 23, wherein each of the first plurality of blocks comprises at least one of a layer of the first machine learning model or a transformer of the first machine learning model.

25. The processor-implemented method of claim 23, wherein:
the first machine learning model was trained based on training data from a source domain,
the third machine learning model is trained using adjustment data from the source domain, and
the third machine learning model is trained without using labels for the adjustment data.

26. The processor-implemented method of claim 25, wherein training the third machine learning model comprises generating an adjustment loss for a first block of the third plurality of blocks based on:
(i) a first feature map generated by a first block of the first plurality of blocks based on a first exemplar in the adjustment data;
(ii) a second feature map generated by a first block of the second plurality of blocks based on the first exemplar, wherein the first block from the second plurality of blocks comprises a quantized version of the first block from the first plurality of blocks; and
(iii) a third feature map generated by the first block of the third plurality of blocks based on the first exemplar, wherein the first block of the third plurality of blocks corresponds to the first block of the second plurality of blocks.

27. The processor-implemented method of claim 25, wherein training the third machine learning model comprises generating an adjustment loss for a first block of the third plurality of blocks based on:
(i) a first model output generated by the first machine learning model based on a first exemplar in the adjustment data;
(ii) a second model output generated by the second machine learning model based on the first exemplar; and
(iii) a third model output generated by the third machine learning model based on the first exemplar.

28. The processor-implemented method of claim 25, further comprising adapting the third machine learning model to a target domain based on labeled adaptation data for the target domain, wherein the second machine learning model is frozen during adaptation to the target domain.

29. The processor-implemented method of claim 23, wherein:
parameters of the second machine learning model are encoded using a first value representation,
parameters of the third machine learning model are encoded using a second value representation, and
the second value representation has a higher precision than the first value representation.

30. The processor-implemented method of claim 23, wherein deploying the second machine learning model and the third machine learning model for inferencing comprises deploying the second machine learning model to be executed on a first hardware component and deploying the third machine learning model to be executed on a second hardware component.
